(19) United States
(12) Patent Application Publication
(10) Pub. No.: US 2026/0235186 A1
(43) Pub. Date: Aug. 13, 2026

(54) SHOCK ABSORBER

(71) Applicant: KYB Corporation, Tokyo (JP)

(72) Inventor: Takeshi YASUI, Tokyo (JP)

(73) Assignee: KYB Corporation, Tokyo (JP)

(21) Appl. No.: 19/154,635

(22) PCT Filed: Apr. 16, 2024
(86) PCT No.: PCT/JP2024/015124

§ 371 Date: Aug. 7, 2025

(30) Foreign Application Priority Data
May 16, 2023 (JP) 2023-081036

(51) Int. Cl. F16F 9/516; B60G 13/08; B60G 17/08; F16F 9/06; F16F 9/18; F16F 9/34

(52) U.S. Cl. CPC F16F 9/516; F16F 9/185; F16F 9/34; B60G 13/08; B60G 17/08; B60G 2202/24; B60G 2204/62; B60G 2206/41; B60G 2500/104; B60G 2500/114; B60G 2600/21; B60G 2800/162; B60G 2800/916; F16F 9/062; F16F 9/064; F16F 9/066; F16F 2222/12; F16F 2228/066; F16F 2232/08; F16F 2234/02

(57) ABSTRACT

A shock absorber includes a cylinder, a piston rod, a piston connected to the piston rod and partitioning the inside of the cylinder into an extension side chamber and a compression side chamber, an outer tube forming a reservoir between the outer tube and the cylinder, an extension side main valve, a compression side main valve and a compression side sub valve provided in series between the compression side chamber and a reservoir, and an extension side sub valve and a suction check valve provided in series between the reservoir and the compression side chamber, in which a damping force is generated only by the extension side sub valve when a piston speed is in a very low speed range during an extension operation, and a damping force is generated only by the compression side sub valve when a piston speed is in the very low speed range during a contraction operation.

### TECHNICAL FIELD

The present invention relates to a shock absorber.

### BACKGROUND ART

A shock absorber is interposed between a vehicle body and a wheel in a vehicle to be used, for example, for the purpose of improving ride comfort in the vehicle, and suppresses vibration of the vehicle body and the wheel by a damping force exerted during extension and contraction.

Such a shock absorber includes, for example, a cylinder, a rod movably inserted into the cylinder, a piston slidably inserted into the cylinder to partition the inside of the cylinder into an extension side chamber and a compression side chamber, a free piston slidably inserted into the cylinder to separate a gas chamber below the compression side chamber in the cylinder, a damping passage provided in the piston to allow communication between the extension side chamber and the compression side chamber, and a damping valve provided in the damping passage.

In recent years, in order to improve ride comfort in a vehicle, there has been a demand for a shock absorber for a vehicle capable of exhibiting a damping force characteristic in which a damping coefficient is increased in a very low speed range, where an extension and contraction speed is lower than a low speed, to quickly increase a damping force in response to switch between extension and contraction strokes, a damping coefficient is smaller in a low speed range than in the very low speed range, and a damping coefficient is smaller in a medium/high speed range exceeding the low speed than in the low speed range while being proportional to the extension and contraction speed.

In order to meet such a demand, for example, as disclosed in JP 2019-183918 A, a damping valve includes: a leaf valve having an annular shape, fixed on an inner circumferential side, and allowed to deflect on an outer circumferential side; and a valve seat member having an annular shape, and having an opposing seat portion having an annular shape and facing an outer circumference of the leaf valve in a non-contact manner, and a port on an inner circumferential side of the opposing seat portion, the damping valve giving resistance to a flow of hydraulic oil flowing between an extension side chamber and a compression side chamber.

In the damping valve configured as described above, when an extension and contraction speed of a shock absorber is in a very low speed range, the leaf valve is not sufficiently deflected and a passage area between the opposing seat portion and the leaf valve is limited to be extremely small. Therefore, a damping force characteristic that rapidly increases according to the extension and contraction speed can be obtained, and a damping force characteristic suitable for a vehicle can be realized.

### CITATION LIST

### Patent Literature

### Patent Literature 1: JP 2019-183918 A

### SUMMARY OF INVENTION

### Technical Problem

A conventional damping valve includes a leaf valve and an opposing seat portion, which can improve a damping force characteristics when a shock absorber expands and contracts at a very low speed. However, when the conventional damping valve is used in a double-cylinder shock absorber having a small cylinder diameter, the opposing seat portion naturally has a small inner diameter, but a portion of the piston rod where the leaf valve is placed cannot have a small outer diameter due to strength issues, and a spacer supporting an inner circumference of the leaf valve also cannot have a small outer diameter, which results in a small difference between inner and outer diameters of the leaf valve.

When the difference between the inner and outer diameters of the leaf valve is small, it is necessary to increase the amount of deflection of the leaf valve in order to ensure a large passage area when the leaf valve deflects away from the opposing seat portion in the axial direction. However, this puts a large stress on the leaf valve, and the leaf valve is fatigued. Therefore, it is difficult to improve the damping force characteristic in the very low speed range by applying the conventional damping valve to the double-cylinder shock absorber.

Therefore, an object of the present invention is to provide a shock absorber capable of improving a damping force characteristic when a piston speed is in a very low speed range and improving ride comfort in a vehicle even in a case where the shock absorber is a double-cylinder shock absorber.

### Solution to Problem

In order to achieve the above-described object, a shock absorber according to the present invention includes: a cylinder; a piston rod inserted into the cylinder so as to be movable in an axial direction; a piston connected to the piston rod, and inserted into the cylinder so as to movable in the axial direction to partition the inside of the cylinder into an extension side chamber and a compression side chamber filled with liquid; an outer tube covering an outer circumference of the cylinder to form a reservoir between the outer tube and the cylinder; an extension side main valve giving resistance to a flow of liquid from the extension side chamber toward the compression side chamber; a compression side main valve and a compression side sub valve provided in series between the compression side chamber and the reservoir, and giving resistance to a flow of liquid from the compression side chamber toward the reservoir; an extension side sub valve provided between the reservoir and the compression side chamber, and giving resistance to a flow of liquid from the reservoir toward the compression side chamber; and a suction check valve provided in series with the extension side sub valve between the reservoir and the compression side chamber, and allowing only a flow of liquid from the reservoir toward the compression side chamber, in which a damping force is generated only by the extension side sub valve when a piston speed is in a very low speed range during an extension operation, and a damping force is generated only by the compression side sub valve when a piston speed is in the very low speed range during a contraction operation.

In the shock absorber configured as described above, when a piston speed is in the very low speed range, a damping force can be generated by the extension side sub valve or the compression side sub valve provided between the compression side chamber and the reservoir, and the extension side sub valve and the compression side sub valve do not need to be provided on the piston rod, making it possible to form a large passage area when the extension side sub valve and the compression side sub valve are opened.

### BRIEF DESCRIPTION OF DRAWINGS

FIG. 1 is a longitudinal cross-sectional view of a shock absorber according to one embodiment of the present invention.

FIG. 2 is a partially enlarged longitudinal cross-sectional view of the shock absorber according to one embodiment of the present invention.

FIG. 3 is a plan view of a first partition wall of the shock absorber according to one embodiment of the present invention.

FIG. 4 is a diagram illustrating a damping force characteristic of the shock absorber according to one embodiment of the present invention.

FIG. 5 is a partially enlarged longitudinal cross-sectional view of a shock absorber according to a modification of one embodiment of the present invention.

### DESCRIPTION OF EMBODIMENTS

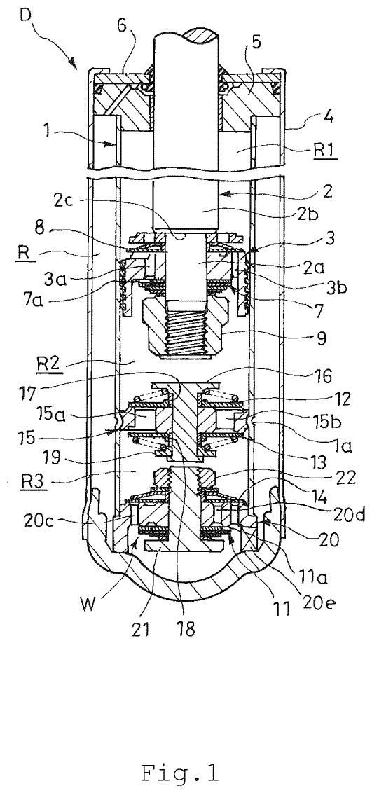

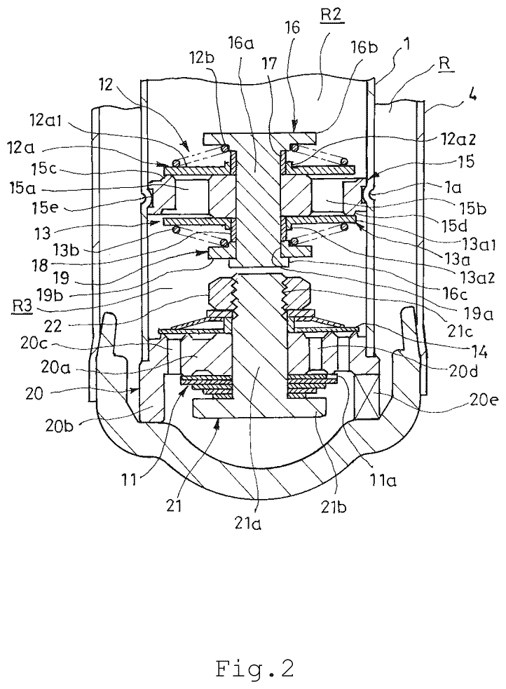

Hereinafter, the present invention will be described based on an embodiment illustrated in the drawings. As illustrated in FIGS. 1 and 2, a shock absorber D according to one embodiment includes: a cylinder 1; a piston rod 2 inserted into the cylinder 1 so as to be movable in an axial direction; a piston 3 connected to the piston rod 2, and inserted into the cylinder 1 so as to movable in the axial direction to partition the inside of the cylinder 1 into an extension side chamber R1 and a compression side chamber R2 filled with liquid; an outer tube 4 covering an outer circumference of the cylinder 1 to form a reservoir R between the outer tube 4 and the cylinder 1; an extension side main valve 7 giving resistance to a flow of liquid from the extension side chamber R1 toward the compression side chamber R2; a compression side main valve 11 and a compression side sub valve 13 provided in series between the compression side chamber R2 and the reservoir R, and giving resistance to a flow of liquid from the compression side chamber R2 toward the reservoir R; an extension side sub valve 12 provided between the reservoir R and the compression side chamber R2, and giving resistance to a flow of liquid from the reservoir R toward the compression side chamber R2; and a suction check valve 14 provided in series with the extension side sub valve 12 between the reservoir R and the compression side chamber R2, and allowing only a flow of liquid from the reservoir R toward the compression side chamber R2. The shock absorber D is interposed between a vehicle body and an axle in a vehicle (not illustrated), and generates a damping force during extension and contraction to suppress vibration of the vehicle body.

Hereinafter, each part of the shock absorber D will be described in detail. The cylinder 1 has a cylindrical shape, and the piston 3 is movably inserted therein as described above. The inside of the cylinder 1 is partitioned by the piston 3 into the extension side chamber R1 above the piston 3 in FIG. 1 and the compression side chamber R2 below the piston 3 in FIG. 1. The extension side chamber R1 and the compression side chamber R2 in the cylinder 1 are filled with, for example, hydraulic oil as liquid. Instead of the hydraulic oil, each of the extension side chamber R1 and the compression side chamber R2 may also be filled with, for example, water or an aqueous solution as liquid.

The outer tube 4 having a bottomed cylindrical shape and covering the outer circumference of the cylinder 1 is provided on an outer circumference side of the cylinder 1. An annular gap is provided between the outer tube 4 and the cylinder 1, and the reservoir R is formed by the annular gap. In this manner, the shock absorber D is configured as a double-cylinder shock absorber. The reservoir R is filled with gas in addition to the same liquid as the liquid filled in the cylinder 1. Note that, when the liquid is used as the hydraulic oil, the gas filled in the reservoir R is preferably inert gas such as nitrogen in order to prevent deterioration of the hydraulic oil.

A first partition wall 15 facing the compression side chamber R2 is attached to a lower end side in FIG. 1 in the cylinder 1, and a second partition wall 20 placed on a bottom portion of the outer tube 4 and facing the reservoir R on an outer circumferential side is fitted to a lower end in FIG. 1 of the cylinder 1. The first partition wall 15 and the second partition wall 20 separate the compression side chamber R2 and the reservoir R, and the first partition wall 15 and the second partition wall 20 constitute a partition wall member W. The first partition wall 15 and the second partition wall 20 are spaced apart from each other in the axial direction of the cylinder 1, and separate an intermediate chamber R3 filled with liquid between the first partition wall 15 and the second partition wall 20 in the cylinder 1.

In addition, a rod guide 5 that slidably supports the piston rod 2 is fitted to an upper end in FIG. 1 of the cylinder 1. This rod guide 5 is fitted onto an inner circumference of the outer tube 4, and is fixed to the outer tube 4 together with a seal member 6 stacked on an upper side in FIG. 1 of the rod guide 5 to seal gaps between the outer tube 4, the cylinder 1, and the piston rod 2 by caulking an upper end of the outer tube 4. When the rod guide 5 is fixed to the outer tube 4 in this manner, the cylinder 1 is sandwiched between the rod guide 5 and the second partition wall 20 placed on the bottom portion of the outer tube 4, and the cylinder 1 is also fixed inside the outer tube 4 together with the second partition wall 20. Instead of caulking an opening edge at the upper end of the outer tube 4, a cap may be screwed to an opening portion at the upper end, and the seal member 6, the rod guide 5, the cylinder 1, and the second partition wall 20 may be sandwiched between the cap and the bottom portion of the outer tube 4, thereby fixing these members inside the outer tube 4.

The piston rod 2 has a cylindrical shape, with a reduced outer diameter on a distal end side, and includes a piston fitting portion 2a having a smallest diameter on the distal end side, a large-diameter portion 2b having a larger outer diameter than the piston fitting portion 2a and provided on an upper side in FIG. 2 of the piston fitting portion 2a, a step portion 2c provided at a boundary between the piston fitting portion 2a and the large-diameter portion 2b, and a screw portion (not illustrated) provided on an outer circumference at a distal end of the piston fitting portion 2a.

A bracket (not illustrated) is provided at a proximal end, which is an upper end in FIG. 1, of the piston rod 2, and the piston rod 2 is connected to either the vehicle body or the wheel via the non-illustrated bracket. In addition, a bracket (not illustrated) is also provided at the bottom portion of the outer tube 4, and the outer tube 4 is connected to the other of the vehicle body and the wheel via the non-illustrated bracket.

In this manner, the shock absorber D is interposed between the vehicle body and the wheel. Then, when the vehicle travels on an uneven road surface or the like and the wheels vibrate up and down with respect to the vehicle body, the piston rod 2 moves in and out of the outer tube 4, the shock absorber D extends and contracts, and the piston 3 moves up and down (in the axial direction) in the cylinder 1.

As illustrated in FIG. 1, the piston 3 has an annular shape, and includes an extension side piston port 3a allowing communication between the extension side chamber R1 and the compression side chamber R2, and a compression side piston port 3b allowing communication between the compression side chamber R2 and the extension side chamber R1. A compression side check valve 8 having an annular shape is overlaid on an upper side in FIG. 1 of the piston 3, and an extension side main valve 7 having an annular shape is overlaid on a lower side in FIG. 1 of the piston 3. Then, the compression side check valve 8, the piston 3, and the extension side main valve 7 are sequentially fitted onto the outer circumference of the piston fitting portion 2a of the piston rod 2, and are sandwiched between a piston nut 9 screwed to the screw portion (not illustrated) at a distal end of the piston rod 2 and the step portion 2c and fixed to the piston rod 2.

The extension side main valve 7 is a laminate leaf valve formed by laminating a plurality of annular shape plates, is overlaid on a compression side chamber side, which is a lower side in FIG. 1, of the piston 3 to open and close an outlet end of the extension side piston port 3a. An orifice 7a formed by a notch (not illustrated) is provided on an outer circumference of an annular shape plate abutting on the piston 3 of the extension side main valve 7. The orifice 7a may be formed by a recess provided by stamping or the like in a valve seat (not illustrated) surrounding the extension side piston port 3a in the piston 3, or may be provided in the compression side check valve 8 to be described later or a valve seat (not illustrated) on which or the compression side check valve 8 is seated.

In addition, an inner circumference of the extension side main valve 7 is fixed to the piston rod 2, while allowing deflection on an outer circumferential side. When the pressure in the extension side chamber R1 becomes higher than the pressure in the compression side chamber R2 and the pressure difference between the two chambers reaches a valve opening pressure, the extension side main valve 7 is bent and opened by receiving the pressure in the extension side chamber R1 acting via the extension side piston port 3a, and the extension side piston port 3a is opened to allow the extension side chamber R1 and the compression side chamber R2 to communicate with each other. Then, the extension side main valve 7 gives resistance to a flow of liquid passing through the extension side piston port 3a, increasing the pressure in the extension side chamber R1.

On the other hand, when the pressure in the compression side chamber R2 is higher than the pressure in the extension side chamber R1, the extension side main valve 7 is pressed against the piston 3 by the pressure in the compression side chamber R2 acting from the back side, and closes the extension side piston port 3a. When the extension side main valve 7 is closed, the extension side piston port 3a communicates with the compression side chamber R2 only through the orifice 78.

The number of annular shape plates laminated in the extension side main valve 7 can be arbitrarily changed according to a desired damping force. The extension side main valve 7 is a leaf valve, but may be a valve other than the leaf valve as long as it can provide resistance to a flow of liquid passing through the second compression side port 20d.

On the other hand, the compression side check valve 8 includes an annular shape plate movable in a direction toward and away from the piston 3 in the axial direction, and a spring biasing the annular shape plate toward the piston 3. The compression side check valve 8 is overlaid on an extension side chamber side, which is an upper side in FIG. 1, of the piston 3 to open and close an outlet end of the compression side piston port 3b. When the pressure in the compression side chamber R2 becomes higher than the pressure in the extension side chamber R1, and the compression side check valve 8 moves away from the piston 3 and is opened by receiving the pressure in the compression side chamber R2 acting via the compression side piston port 3b, the compression side piston port 3b is opened to allow communication between the compression side chamber R2 and the extension side chamber R1. When the compression side check valve 8 is opened, liquid is allowed to pass through the compression side piston port 3b without giving much resistance. On the other hand, when the pressure in the extension side chamber R1 is higher than the pressure in the compression side chamber R2, the compression side check valve 8 is pressed against the piston 3 by the pressure in the extension side chamber R1 acting from the back side, and closes the compression side piston port 3b, thereby blocking communication between the compression side chamber R2 and the extension side chamber R1.

Next, the compression side main valve 11, the compression side sub valve 13, the extension side sub valve 12, and the suction check valve 14 will be described. As illustrated in FIG. 2, the compression side main valve 11 and the suction check valve 14 are provided on the second partition wall 20, and the compression side sub valve 13 and the extension side sub valve 12 are provided on the first partition wall 15.

The second partition wall 20 is sandwiched between the cylinder 1 and the bottom portion of the outer tube 4, is attached to the lower end in FIG. 2 of the cylinder 1, and faces the reservoir R. The first partition wall 15 is provided below the cylinder 1 and away from the second partition wall 20, faces the compression side chamber R2, and forms an intermediate chamber R3 between the first partition wall 15 and the second partition wall 20 in the cylinder 1. In this manner, the first partition wall 15 and the second partition wall 20 are provided between the compression side chamber R2 and the reservoir R, and partition the compression side chamber R2 and the reservoir R.

More specifically, the second partition wall 20 includes: a partition wall main body 20a having a circular annular shape and fitted onto the inner circumference of the cylinder 1; a flange portion 20b having an annular shape, continuous with a lower end in FIG. 2 of the partition wall main body 20a, having an outer diameter larger than an outer diameter of the partition wall main body 20a and an inner diameter smaller than the outer diameter of the partition wall main body 20a, and sandwiched between the lower end of the cylinder 1 and the bottom portion of the outer tube 4; and a second extension side port 20c and a second compression side port 20d penetrating the partition wall main body 20a in the axial direction.

In addition, a second attachment shaft 21 is inserted through an inner circumference of the partition wall main body 20a of the second partition wall 20, and the compression side main valve 11 and the suction check valve 14 are placed on an outer circumference of the second attachment shaft 21.

In the flange portion 20b of the second partition wall 20, a plurality of notches 20e open from a lower end in FIG. 2 are provided at equal intervals in the circumferential direction, ensuring communication between voids in the flange portion 20b and the reservoir R.

Both one ends of the second extension side port 20c and the second compression side port 20d communicate with the intermediate chamber R3 between the first partition wall 15 and the second partition wall 20, and both the other ends of the second extension side port 20c and the second compression side port 20d communicate with the reservoir R via the voids in the flange portion 20b, thereby enabling communication between the intermediate chamber R3 and the reservoir R.

The compression side main valve 11 is a laminate leaf valve formed by laminating a plurality of annular shape plates, is overlaid on a reservoir side, which is a lower side in FIG. 2, of the partition wall main body 20a in the second partition wall 20 to open and close an outlet end of the second compression side port 20d. An inner circumference of the compression side main valve 11 is fixed to the second attachment shaft 21, while allowing deflection on an outer circumferential side. When the pressure in the intermediate chamber R3 becomes higher than the pressure in the reservoir R and the pressure difference between the two chambers reaches a valve opening pressure, the compression side main valve 11 is bent and opened by receiving the pressure in the intermediate chamber R3 acting via the second compression side port 20d, and the second compression side port 20d is opened to allow the intermediate chamber R3 and the reservoir R to communicate with each other. An orifice 11a formed by a notch is provided on an outer circumference of an annular shape plate abutting on the second partition wall 20 of the compression side main valve 11. The orifice 11a may be formed by a recess provided by stamping or the like in a valve seat surrounding the second compression side port 20d in the second partition wall 20, or may be provided in the suction check valve 14 to be described later or a valve seat (not illustrated) on which the suction check valve 14 is seated.

In this manner, the compression side main valve 11 gives resistance to a flow of liquid passing through the second compression side port 20d, increasing the pressure in the intermediate chamber R3. On the other hand, when the pressure in the reservoir R is higher than the pressure in the intermediate chamber R3, the compression side main valve 11 is pressed against the piston 3 by the pressure in the reservoir R acting from the back side, and closes the second compression side port 20d. When the compression side main valve 11 is closed, the second compression side port 20d communicates with the reservoir R only through the orifice 11a.

The number of annular shape plates laminated in the compression side main valve 11 can be arbitrarily changed according to a desired damping force. The compression side main valve 11 is a leaf valve, but may be a valve other than the leaf valve as long as it can provide resistance to a flow of liquid passing through the second compression side port 20d.

On the other hand, the suction check valve 14 includes an annular shape plate movable in a direction toward and away from the second partition wall 20 in the axial direction and a spring biasing the annular valve body toward the second partition wall 20. The suction check valve 14 is overlaid on an intermediate chamber side, which is an upper side in FIG. 2, of the partition wall main body 20a in the second partition wall 20 to open and close an outlet end of the second extension side port 20c. When the pressure in the reservoir R becomes higher than the pressure in the intermediate chamber R3, and the suction check valve 14 is bent away from the second partition wall 20 and opened by receiving the pressure in the reservoir R acting via the second extension side port 20c, the second extension side port 20c is opened to allow the reservoir R and the intermediate chamber R3 to communicate with each other. When the suction check valve 14 is opened, liquid is allowed to pass through the second extension side port 20c without giving much resistance. On the other hand, when the pressure in the intermediate chamber R3 is higher than the pressure in the reservoir R, the suction check valve 14 is pressed against the second partition wall 20 by the pressure in the intermediate chamber R3 acting from the back side to close the second extension side port 20c, thereby blocking communication between the intermediate chamber R3 and the reservoir R.

The compression side main valve 11 and the suction check valve 14 configured as described above are fitted onto the outer circumference of the second attachment shaft 21 together with the second partition wall 20. The second attachment shaft 21 includes a shaft portion 21a inserted into the inner circumferences of the second partition wall 20, the compression side main valve 11, and the suction check valve 14, a flange 21b provided at a lower end in FIG. 2 of the shaft portion 21a, and a screw portion 21c provided at an upper end in FIG. 2, which is a distal end, of the shaft portion 21a. The second attachment shaft 21 holds the second partition wall 20, the compression side main valve 11, and the suction check valve 14 fitted onto the outer circumference of the shaft portion 21a, by the flange 21b and a nut 22 screwed to the screw portion 21c, around the inner circumferences of the second partition wall 20, the compression side main valve 11, and the suction check valve 14.

The first partition wall 15 is attached below the cylinder 1 at a position away from and above the second partition wall 20. Specifically, the first partition wall 15 has a circular annular shape, and includes a first extension side port 15a and a first compression side port 15b penetrating in the axial direction, and an annular shape groove 15e provided on an outer circumference along the circumferential direction. Then, the first partition wall 15 is fixed to the cylinder 1 as a caulking portion la plastically deformed by caulking the cylinder 1 from the outer circumference enters the annular shape groove 15e. In addition, as the caulking portion la enters the annular shape groove 15e in this manner, a space between the first partition wall 15 and the cylinder 1 is sealed, preventing the compression side chamber R2 and the intermediate chamber R3 from communicating with each other through the space between the first partition wall 15 and the cylinder 1.

As described above, the first partition wall 15 is provided below the cylinder 1 and away from the second partition wall 20, faces the compression side chamber R2, and forms an intermediate chamber R3 between the first partition wall 15 and the second partition wall 20 in the cylinder 1.

In addition, a first attachment shaft 16 is inserted through an inner circumference of the first partition wall 15, and the extension side sub valve 12 and the compression side sub valve 13 are attached onto an outer circumference of the first attachment shaft 16.

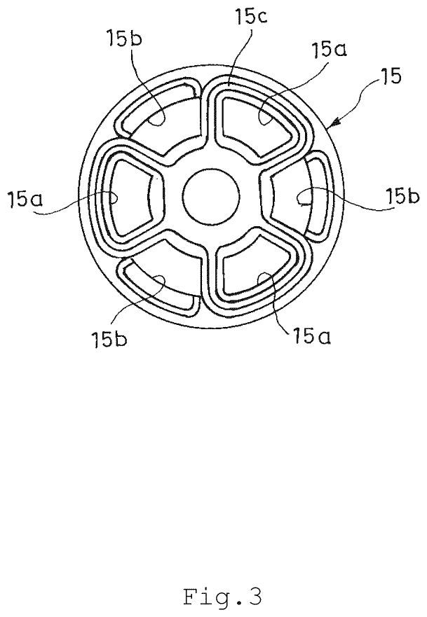

As illustrated in FIG. 3, three first extension side ports 15a and three first compression side ports 15b are provided in the first partition wall 15 in an alternate manner in the circumferential direction on the same circumference. Both one ends of the first extension side port 15a and the first compression side port 15b communicate with the compression side chamber R2 above the first partition wall 15, and both the other ends of the first extension side port 15a and the first compression side port 15b communicate with the intermediate chamber R3 between the first partition wall 15 and the second partition wall 20, thereby enabling communication the compression side chamber R2 and the intermediate chamber R3.

A petal-type extension side valve seat 15c surrounding an outlet end of the first extension side port 15a is provided at an upper end in FIG. 2 of the first partition wall 15 on the compression side chamber side so as to protrude toward the compression side chamber side, and a petal-type compression side valve seat 15d surrounding an outlet end of the first compression side port 15b is provided at a lower end in FIG. 2 of the first partition wall 15 on the intermediate chamber side so as to protrude toward the intermediate chamber side.

The extension side sub valve 12 has an annular shape, and is movable toward and away from the first partition wall 15 in the axial direction. The extension side sub valve 12 includes an extension side valve body 12a overlaid on the compression side chamber side, which is the upper end in FIG. 2 of the first partition wall 15, and an extension side spring 12b biasing the extension side valve body 12a toward the first partition wall 15. The extension side valve body 12a includes a valve portion 12al that has a circular annular shape, and seats on and off the extension side valve seat 15c, and an annular shape guide portion 12a2 that rises from an inner circumference of the valve portion 12a1 toward the side opposite to the first partition wall. When the extension side valve body 12a abuts against the extension side valve seat 15c, the extension side valve body 12a is in tight contact with the extension side valve seat 15c without any gap and closes the first extension side port 15a without any gap. When the extension side valve body 12a moves away from the extension side valve seat 15c, the first extension side port 15a can be opened.

In addition, an inner circumference of the guide portion 12a2 of the extension side valve body 12a is in sliding contact with an outer circumference of a tubular collar 17 fitted onto the outer circumference of the first attachment shaft 16, and the extension side valve body 12a is placed to be movable in the axial direction with respect to the first attachment shaft 16. In this manner, a movement in the axial direction of the extension side valve body 12a is guided by the collar 17, and the extension side valve body 12a is movable toward and away from the first partition wall 15. The collar 17 functions as a center rod that rises from the first partition wall 15 and is inserted into the inner circumference of the extension side valve body 12a, and an outer diameter of the collar 17 is smaller than an outer diameter of the piston fitting portion 2a of the piston rod 2. An inner diameter of the extension side valve body 12a, which is in sliding contact with an outer circumference of the collar 17, is smaller than an inner diameter of the laminate leaf valve constituting the compression side main valve 11 placed on the outer circumference of the piston fitting portion 2a. In addition, an inner diameter of the extension side valve body 12a is smaller than an inner diameter of the laminate leaf valve constituting the compression side main valve 11 placed on the outer circumference of the piston fitting portion 2a.

The compression side sub valve 13 has an annular shape, and is movable toward and away from the first partition wall 15 in the axial direction. The compression side sub valve 13 includes a compression side valve body 13a overlaid on the intermediate chamber side, which is the lower end in FIG. 2 of the first partition wall 15, and a compression side spring 13b biasing the compression side valve body 13a toward the first partition wall 15. The compression side valve body 13a includes a valve portion 13al that has a circular annular shape, and seats on and off the compression side valve seat 15d, and an annular shape guide portion 13a2 that rises from an inner circumference of the valve portion 13al toward the side opposite to the first partition wall. When the compression side valve body 13a abuts against the compression side valve seat 15d, the compression side valve body 13a is in tight contact with the compression side valve seat 15d without any gap and closes the first compression side port 15b. When the compression side valve body 13a moves away from the compression side valve seat 15d, the first compression side port 15b can be opened.

In addition, an inner circumference of the guide portion 13a2 of the compression side valve body 13a is in sliding contact with an outer circumference of a tubular collar 18 fitted onto the outer circumference of the first attachment shaft 16, and the compression side valve body 13a is placed to be movable in the axial direction with respect to the first attachment shaft 16. In this manner, a movement in the axial direction of the compression side valve body 13a is guided by the collar 18, and the compression side valve body 13a is movable toward and away from the first partition wall 15. The collar 18 functions as a center rod that rises from the first partition wall 15 and is inserted into the inner circumference of the compression side valve body 13a, and an outer diameter of the collar 18 is smaller than an outer diameter of the shaft portion 21a of the second attachment shaft 21 on which the compression side main valve 11 is placed. Therefore, an inner diameter of the compression side valve body 13a, which is in sliding contact with the outer circumference of the collar 18, is smaller than an inner diameter of the laminate leaf valve constituting the compression side main valve 11 placed on the outer circumference of the piston fitting portion 2a.

The first attachment shaft 16 includes a shaft portion 16a inserted into the inner circumferences of the first partition wall 15, the collars 17 and 18, the extension side sub valve 12, the compression side sub valve 13, and the spring seat 19, a flange 16b provided at an upper end in FIG. 2 of the shaft portion 16a, and a flange portion 16c formed by caulking a lower end in FIG. 2 of the shaft portion 16a. The first attachment shaft 16 holds the collar 17, the first partition wall 15, the collar 18, and the spring seat 19 fitted onto the outer circumference of the shaft portion 16a by sandwiching the collar 17, the first partition wall 15, the collar 18, and the spring seat 19 between the flange 16b and the flange portion 16c. Therefore, the collar 17, the first partition wall 15, the collar 18, and the spring seat 19 are immovably fixed to the outer circumference of the shaft portion 16a of the first attachment shaft 16.

The guide portion 12a2 of the extension side valve body 12a in the extension side sub valve 12 is in sliding contact with the outer circumference of the collar 17, and the extension side valve body 12a is movable in the axial direction with respect to the collar 17 held by the shaft portion 16a, The extension side spring 12b is interposed between the valve portion 12al of the extension side valve body 12a and the flange 16b on the outer circumference of the collar 17, and constantly biases the extension side valve body 12a toward the first partition wall 15. In addition, the extension side spring 12b is a conical coil spring and has a short close-contact length, making it easy to ensure the stroke length of the extension side valve body 12a with respect to the first partition wall 15 even if the overall length of the extension side sub valve 12 is shortened. However, the extension side spring 12b may be a cylindrical coil spring, a wave washer, or another elastic body. The extension side spring 12b has a small spring constant, and the extension side spring 12b biasing the extension side valve body 12a also has a small biasing force in a state where the extension side valve body 12a is seated on the first partition wall 15, so that the extension side valve body 12a moves away greatly from the first partition wall 15 when the valve is opened.

The spring seat 19 includes a cylindrical portion 19a fitted onto tan outer circumference of the shaft portion 16a, and a seat portion 19b having an annular shape and protruding from a lower end of the cylindrical portion 19a toward an outer circumference in a radial direction, and is attached to the first attachment shaft 16 while being overlaid on a lower side of the collar 18.

Further, the guide portion 13a2 of the compression side valve body 13a in the compression side sub valve 13 is in sliding contact with the outer circumference of the collar 18, and the compression side valve body 13a is movable in the axial direction with respect to the collar 18 held by the shaft portion 16a. The compression side spring 13b is interposed between the valve portion 13al of the compression side valve body 13a and the seat portion 19b of the spring seat 19 on the outer circumference of the collar 18, and constantly biases the compression side valve body 13a toward the first partition wall 15. In addition, the compression side spring 13b is a conical coil spring and has a short close-contact length, making it easy to ensure the stroke length of the compression side valve body 13a with respect to the first partition wall 15 even if the overall length of the compression side sub valve 13 is shortened. However, the compression side spring 13b may be a cylindrical coil spring, a wave washer, or another elastic body. The compression side spring 13b has a small spring constant, and the compression side spring 13b biasing the compression side valve body 13a also has a small biasing force in a state where the compression side valve body 13a is seated on the first partition wall 15, so that the compression side valve body 13a moves away greatly from the first partition wall 15 when the valve is opened.

Then, when the pressure in the compression side chamber R2 is reduced during an extension operation of the shock absorber D, the extension side sub valve 12 configured as described above moves away from the first partition wall 15 and away from the extension side valve seat 15c, by receiving the pressure in the intermediate chamber R3, to open the first extension side port 15a. During the extension operation of the shock absorber D, the pressure in the intermediate chamber R3 is also reduced, and accordingly, the suction check valve 14 provided on the second partition wall 20 is also opened to open the second extension side port 20c. On the other hand, during a contraction operation of the shock absorber D, the extension side sub valve 12 is pressed against the first partition wall 15 and is seated on the extension side valve seat 15c, by receiving the pressure in the compression side chamber R2, to block the first extension side port 15a, and the suction check valve 14 provided on the second partition wall 20 is also closed, by receiving the boosted pressure in the intermediate chamber R3, to block the second extension side port 20c. Therefore, the extension side sub valve 12 and the suction check valve 14 are provided in series between the compression side chamber R2 and the reservoir R with the reservoir R being located upstream.

The extension side sub valve 12 and the extension side main valve 7 are opened during the extension operation of the shock absorber D, but a valve opening pressure of the extension side sub valve 12 is lower than a valve opening pressure of the extension side main valve 7, and the extension side sub valve 12 is opened at a timing earlier than the extension side main valve 7 during the extension and contraction operation of the shock absorber D.

In addition, during the contraction operation of the shock absorber D, the compression side sub valve 13 moves away from the first partition wall 15 and away from the compression side valve seat 15d, by receiving the boosted compression side chamber R2, to open the first compression side port 15b. During the contraction operation of the shock absorber D, when the pressure in the intermediate chamber R3 is boosted and the pressure difference between the intermediate chamber R3 and the reservoir R reaches the valve opening pressure of the compression side main valve 11, the compression side main valve 11 is also opened to open the second compression side port 20d. On the other hand, during the contraction operation of the shock absorber D, the compression side sub valve 13 is pressed against the first partition wall 15 and is seated on the compression side valve seat 15d, by receiving the pressure in the intermediate chamber R3, to block the first compression side port 15b, and the compression side main valve 11 provided on the second partition wall 20 is also closed, by receiving the pressure in the reservoir R because the pressure in the intermediate chamber R3 is reduced, to block the second compression side port 20d. Therefore, the compression side sub valve 13 and the compression side main valve 11 are provided in series between the compression side chamber R2 and the reservoir R with the compression side chamber R2 being located upstream.

The compression side sub valve 13 and the compression side main valve 11 are opened during the contraction operation of the shock absorber D, but a valve opening pressure of the compression side sub valve 13 is lower than a valve opening pressure of the compression side main valve 11, and the compression side sub valve 13 is opened at a timing earlier than the compression side main valve 11 during the contraction operation of the shock absorber D.

The operation of the shock absorber D configured as described above will be described. First, the operation of the shock absorber D during an extension operation, in which the piston 3 moves upward in FIG. 1 with respect to the cylinder 1, will be described.

When the piston 3 moves upward in FIG. 1 with respect to the cylinder 1, the extension side chamber R1 is reduced and the compression side chamber R2 is enlarged in accordance with the movement of the piston 3. When a piston speed, which is a moving speed of the piston 3 with respect to the cylinder 1 during the extension operation of the shock absorber D, is in a very low speed range, the difference between the pressure in the extension side chamber R1 and the pressure in the compression side chamber R2 does not reach the valve opening pressure of the extension side main valve 7, so that the extension side main valve 7 is not deflected and is in a closed state, and thus, the liquid in the reduced extension side chamber R1 passes through the extension side piston port 3a and the orifice 7a and moves to the compression side chamber R2. When the piston speed is in the very low speed range, the flow rate of the liquid flowing through the orifice 7a is extremely low, and accordingly, the resistance given to the flow of the liquid by the orifice 7a is also extremely small.

During the extension operation of the shock absorber D, the piston rod 2 moves upward in FIG. 1 and is retracted from the inside of the cylinder 1, reducing the volume of the piston rod 2 pushed down in the cylinder 1, thereby causing a shortage of liquid in the cylinder 1 as much as the volume by which the piston rod 2 is retracted from the inside of the cylinder 1. By doing so, the suction check valve 14 is opened to allow communication between the reservoir R and the intermediate chamber R3 through the second extension side port 20c, and the extension side sub valve 12 is opened to allow communication between the intermediate chamber R3 and the compression side chamber R2 through the first extension side port 15a. Then, the extension side sub valve 12 gives resistance to the flow of liquid passing through the first extension side port 15a, and as a result, the pressure in the compression side chamber R2 is reduced to be lower than the pressure in the extension side chamber R1.

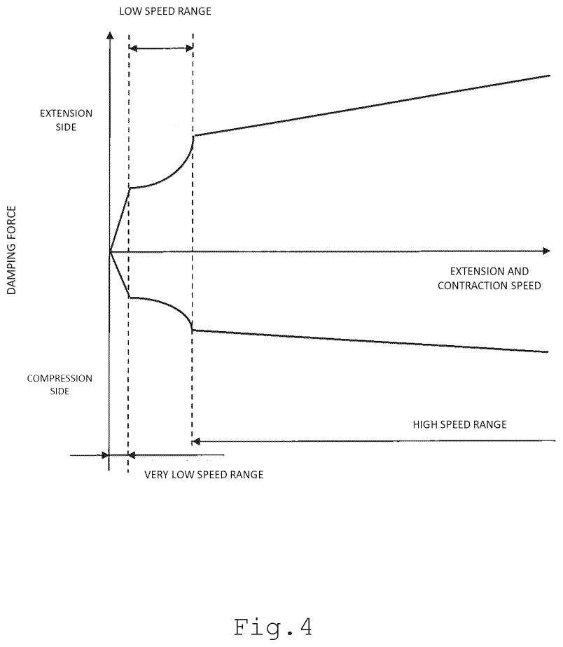

Therefore, when the piston speed is in the very low speed range during the extension operation of the shock absorber D, as illustrated in FIG. 4, a damping force that hinders the extension operation of the shock absorber D is generated by the resistance that the extension side sub valve 12 gives to the flow of the liquid, and the damping force characteristic, which is a characteristic regarding the damping force with respect to the piston speed, has a high damping coefficient, and the damping force rises quickly as the piston speed increases.

In addition, the amount of liquid passing through the extension side sub valve 12 is equal to the volume by which the piston rod 2 is retracted from the cylinder 1, and the amount of liquid passing through the extension side sub valve 12 can be reduced as compared with that in a case where the extension side sub valve 12 is provided in the piston portion. In addition, even in a double-cylinder shock absorber D in which the cylinder 1 cannot have a large outer diameter, the difference between the inner diameter and the outer diameter of the extension side sub valve 12 can be large because the extension side sub valve 12 is provided on the outer circumference of the collar 17 having a diameter smaller than the outer diameter of the piston fitting portion 2a of the piston rod 2. Therefore, even in a double-cylinder shock absorber D in which it is difficult to form the cylinder 1 to have a large outer diameter, the resistance given to the flow of liquid by the extension side sub valve 12 after being opened is smaller than that in a case where the extension side sub valve is provided in the piston portion, and the damping force is not excessive.

Subsequently, when the piston speed is in a low speed range exceeding the very low speed range during the extension operation of the shock absorber D, the difference between the pressure in the extension side chamber R1 and the pressure in the compression side chamber R2 increases but does not yet reach the valve opening pressure of the extension side main valve 7, so that the extension side main valve 7 does not bend and remains closed, and thus, the liquid in the reduced extension side chamber R1 passes through the extension side piston port 3a and the orifice 7a and moves to the compression side chamber R2. When the piston speed is within the low speed range, the flow rate of the liquid flowing through the orifice 7a increases, and accordingly, the resistance given to the flow of the liquid by the orifice 7a increases.

When the piston speed is in the low speed range during the extension operation of the shock absorber D, both the suction check valve 14 and the extension side sub valve 12 are opened, but the extension side valve body 12a of the extension side sub valve 12 moves away greatly from the first partition wall 15, and thus, the resistance given to the flow of liquid by the extension side sub valve 12 is smaller than the resistance given to the flow of liquid by the orifice 7a.

Therefore, when the piston speed is in the low speed range during the extension operation of the shock absorber D, as illustrated in FIG. 4, a damping force that hinders the extension operation of the shock absorber D is generated mainly by the resistance given to the flow of the liquid by the orifice 7a. Therefore, when the piston speed is in the low speed range during the extension operation of the shock absorber D, the shock absorber D generates a damping force proportional to the square of the piston speed specific to the orifice, and the damping force characteristic is a characteristic in which the damping coefficient is lower than that when the piston speed is in the very low speed range.

Furthermore, when the piston speed is in a high speed range exceeding the low speed range during the extension operation of the shock absorber D, the difference between the pressure in the extension side chamber R1 and the pressure in the compression side chamber R2 increases to exceed the valve opening pressure of the extension side main valve 7, and the liquid in the reduced extension side chamber R1 pushes and opens the extension side main valve 7, passes through the extension side piston port 3a, and moves to the compression side chamber R2.

When the piston speed is in the high speed range during the extension operation of the shock absorber D, both the suction check valve 14 and the extension side sub valve 12 are opened, but the extension side valve body 12a of the extension side sub valve 12 moves away greatly from the first partition wall 15, and thus, the resistance given to the flow of liquid by the extension side sub valve 12 is smaller than the resistance given to the flow of liquid by the extension side main valve 7.

Therefore, when the piston speed is in the high speed range during the extension operation of the shock absorber D, as illustrated in FIG. 4, a damping force that hinders the extension operation of the shock absorber D is generated mainly by the resistance given to the flow of the liquid by the extension side main valve 7. Therefore, the damping force characteristic when the piston speed is in the high speed range during the extension operation of the shock absorber D is a characteristic in which the damping force increases generally linearly with the piston speed although the damping coefficient is lower than that when the piston speed is a low speed.

Next, the operation of the shock absorber D during a contraction operation, in which the piston 3 moves downward in FIG. 1 with respect to the cylinder 1, will be described.

When the piston 3 moves downward in FIG. 1 with respect to the cylinder 1, the compression side chamber R2 is reduced and the extension side chamber R1 is enlarged along in accordance with the movement of the piston 3. When the shock absorber D performs a contraction operation, the compression side check valve 8 is opened, and the liquid in the reduced compression side chamber R2 passes through the compression side piston port 3b and moves to the extension side chamber R1 without receiving much resistance. During the contraction operation of the shock absorber D, the piston rod 2 enters the cylinder 1, and the liquid becomes excessive in the cylinder 1 as much as the volume by which the piston rod 2 enters the cylinder 1, and the excessive liquid tends to move from the inside of the cylinder 1 to the reservoir R.

When the piston speed is in the very low speed range during the contraction operation of the shock absorber D, the difference between the pressure in the compression side chamber R2 and the pressure in the reservoir R is small, but the compression side sub valve 13 is opened to open the first compression side port 15b, and the liquid in the compression side chamber R2 moves to the intermediate chamber R3. On the other hand, when the piston speed is in the very low speed range during the contraction operation of the shock absorber D, the difference between the pressure in the compression side chamber R2 and the pressure in the reservoir R is small, and the difference between the pressure in the intermediate chamber R3 and the pressure in the reservoir R does not reach the valve opening pressure of the compression side main valve 11, so that the compression side main valve 11 is not deflected and is in a closed state, and thus, the liquid in the intermediate chamber R3 moves to the reservoir R through the orifice 11a and the second compression side port 20d. When the piston speed is in the very low speed range, the flow rate of the liquid flowing through the orifice 11a is extremely low, and accordingly, the resistance given to the flow of the liquid by the orifice 11a is also extremely small.

Therefore, when the piston speed is in the very low speed range during the contraction operation of the shock absorber D, the compression side sub valve 13 is opened to give resistance to the flow of liquid passing through the first compression side port 15b, and as a result, the pressures in the compression side chamber R2 and the extension side chamber R1 increase. Since a pressure receiving area on the compression side chamber side of the piston 3 is larger than a pressure receiving area on the extension side chamber side of the piston 3 by the cross-sectional area of the piston rod 2, the force pushing up the piston 3 increases as the pressures in the compression side chamber R2 and the extension side chamber R1 increase, and this becomes a damping force that hinders the contraction of the shock absorber D.

Therefore, when the piston speed is in the very low speed range during the contraction operation of the shock absorber D, as illustrated in FIG. 4, a damping force that hinders the contraction operation of the shock absorber D is generated by the resistance that the compression side sub valve 13 gives to the flow of the liquid, and the damping force characteristic, which is a characteristic regarding the damping force with respect to the piston speed, has a high damping coefficient, and the damping force rises quickly as the piston speed increases.

In addition, the amount of liquid passing through the compression side sub valve 13 is equal to the volume by which the piston rod 2 enters the cylinder 1, and the amount of liquid passing through the compression side sub valve 13 can be reduced as compared with that in a case where the compression side sub valve 13 is provided in the piston portion. In addition, even in a double-cylinder shock absorber D in which the cylinder 1 cannot have a large outer diameter, the difference between the inner diameter and the outer diameter of the compression side sub valve 13 can be large because the compression side sub valve 13 is provided on the outer circumference of the collar 18 having a diameter smaller than the outer diameter of the piston fitting portion 2a of the piston rod 2. Therefore, even in a double-cylinder shock absorber D in which it is difficult to form the cylinder 1 to have a large outer diameter, the resistance given to the flow of liquid by the compression side sub valve 13 after being opened is smaller than that in a case where the extension side sub valve is provided in the piston portion, and the damping force is not excessive.

Subsequently, when the piston speed is in a low speed range exceeding the very low speed range during the contraction operation of the shock absorber D, the difference between the pressure in the compression side chamber R2 and the pressure in the reservoir R increases but does not yet reach the valve opening pressure of the compression side main valve 11, so that the compression side main valve 11 does not bend and remains closed, and thus, the liquid in the reduced compression side chamber R2 passes through the first compression side port 15b, the second compression side port 20d, and the orifice 11a and moves to the reservoir R. When the piston speed is within the low speed range, the flow rate of the liquid flowing through the orifice 11a increases, and accordingly, the resistance given to the flow of the liquid by the orifice 11a increases.

When the piston speed is in the low speed range during the contraction operation of the shock absorber D, the compression side valve body 13a of the compression side sub valve 13 moves away greatly from the first partition wall 15, and thus, the resistance given to the flow of liquid by the compression side sub valve 13 is smaller than the resistance given to the flow of liquid by the orifice 11a.

Therefore, when the piston speed is in the low speed range during the contraction operation of the shock absorber D, as illustrated in FIG. 4, a damping force that hinders the contraction operation of the shock absorber D is generated mainly by the resistance given to the flow of the liquid by the orifice 11a. Therefore, when the piston speed is in the low speed range during the contraction operation of the shock absorber D, the shock absorber D generates a damping force proportional to the square of the piston speed specific to the orifice, and the damping force characteristic is a characteristic in which the damping coefficient is lower than that when the piston speed is in the very low speed range.

Furthermore, when the piston speed is in a high speed range exceeding the low speed range during the contraction operation of the shock absorber D, the difference between the pressure in the compression side chamber R2 and the pressure in the reservoir R increases to exceed the valve opening pressure of the compression side main valve 11, and the liquid in the compression side chamber R2 pushes and opens the compression side main valve 11, passes through the second compression side port 20d, and moves to the reservoir R.

When the piston speed is in the high speed range during the contraction operation of the shock absorber D, the compression side sub valve 13 is opened, but the compression side valve body 13a of the compression side sub valve 13 moves away greatly from the first partition wall 15, and thus, the resistance given to the flow of liquid by the compression side sub valve 13 is smaller than the resistance given to the flow of liquid by the compression side main valve 11.

Therefore, when the piston speed is in the high speed range during the contraction operation of the shock absorber D, as illustrated in FIG. 4, a damping force that hinders the contraction operation of the shock absorber D is generated mainly by the resistance given to the flow of the liquid by the compression side main valve 11. Therefore, the damping force characteristic when the piston speed is in the high speed range during the contraction operation of the shock absorber D is a characteristic in which the damping force increases generally linearly with the piston speed although the damping coefficient is lower than that when the piston speed is a low speed.

As described above, a shock absorber D of the present embodiment includes: a cylinder 1; a piston rod 2 inserted into the cylinder 1 so as to be movable in an axial direction; a piston 3 connected to the piston rod 2, and inserted into the cylinder 1 so as to movable in the axial direction to partition the inside of the cylinder 1 into an extension side chamber R1 and a compression side chamber R2 filled with liquid; an outer tube 4 covering an outer circumference of the cylinder 1 to form a reservoir R between the outer tube 4 and the cylinder 1; an extension side main valve 7 giving resistance to a flow of liquid from the extension side chamber R1 toward the compression side chamber R2; a compression side main valve 11 and a compression side sub valve 13 provided in series between the compression side chamber R2 and the reservoir R, and giving resistance to a flow of liquid from the compression side chamber R2 toward the reservoir R; an extension side sub valve 12 provided between the reservoir R and the compression side chamber R2, and giving resistance to a flow of liquid from the reservoir R toward the compression side chamber R2; and a suction check valve 14 provided in series with the extension side sub valve 12 between the reservoir R and the compression side chamber R2, and allowing only a flow of liquid from the reservoir R toward the compression side chamber R2, in which a damping force is generated only by the extension side sub valve 12 when a piston speed is in a very low speed range during an extension operation, and a damping force is generated only by the compression side sub valve 13 when a piston speed is in the very low speed range during a contraction operation.

In the shock absorber D configured as described above, when a piston speed is in the very low speed range, a damping force can be generated by the extension side sub valve 12 or the compression side sub valve 13 provided between the compression side chamber R2 and the reservoir R, and the extension side sub valve 12 and the compression side sub valve 13 do not need to be provided on the piston rod 2. Since the piston rod 2 receives a lateral force input from a lateral direction orthogonal to the axial direction with respect to the shock absorber D, it is difficult to form the piston rod 2 to have a small diameter, and furthermore, it is difficult to form a cylinder to have a large inner diameter in a double-cylinder shock absorber. Therefore, in a conventional shock absorber, a difference between an inner diameter and an outer diameter of a leaf valve as a damping valve cannot be large. On the other hand, in the shock absorber D of the present embodiment, since the extension side sub valve 12 or the compression side sub valve 13 is provided between the compression side chamber R2 and the reservoir R, the amount of liquid passing through the extension side sub valve 12 or the compression side sub valve 13 during an extension or a contraction of the shock absorber D can be reduced, and it is not necessary to receive a lateral force. Accordingly, it is not necessary to provide the extension side sub valve 12 or the compression side sub valve 13 on the piston rod 2 whose outer diameter cannot be reduced for strength reasons, making it possible to increase the passage area when the extension side sub valve 12 and the compression side sub valve 13 are opened. Therefore, according to the shock absorber D of the present embodiment, even in a case where the shock absorber D is of a double cylinder type, a damping force is not excessive when a piston speed is in the very low speed range, a good damping force characteristic can be achieved, improving the ride comfort in the vehicle. In addition, since the compression side main valve 11 and the compression side sub valve 13 are provided in series between the compression side chamber R2 and the reservoir R, and the extension side sub valve 12 and the suction check valve 14 are provided in series between the reservoir R and the compression side chamber R2, there is no need to adopt a structure in which the compression side sub valve 13 bypasses the compression side main valve 11 and the extension side sub valve 12 bypasses the extension side main valve 7, the compression side sub valve 13 and the extension side sub valve 12 can be easily installed in the narrow cylinder 1 of the double-cylinder shock absorber D, thereby not increasing the size of the shock absorber D.

Further, the shock absorber D of the present embodiment further includes a partition wall member W having a first partition wall 15 and a second partition wall 20 forming an intermediate chamber R3 between the first partition wall 15 and the second partition wall 20, and partitioning the compression side chamber R2 and the reservoir R, in which the first partition wall 15 has a first extension side port 15a and a first compression side port 15b allowing communication between the compression side chamber R2 and the intermediate chamber R3, the second partition wall 20 has a second extension side port 20c and a second compression side port 20d allowing communication between the reservoir R and the intermediate chamber R3, the extension side sub valve 12 and the compression side sub valve 13 are provided on the first partition wall 15, and the compression side main valve 11 and the suction check valve 14 are provided on the second partition wall 20.

According to the shock absorber D configured as described above, by installing the first partition wall 15, on which the extension side sub valve 12 and the compression side sub valve 13 are provided, and the second partition wall 20, on which the compression side main valve 11 and the suction check valve 14 are provided, between the compression side chamber R2 and the reservoir R, the compression side main valve 11 and the compression side sub valve 13 can be provided in series between the compression side chamber R2 and the reservoir R, and the extension side sub valve 12 and the suction check valve 14 can be provided in series between the reservoir R and the compression side chamber R2. Therefore, according to the shock absorber D configured as described above, the compression side main valve 11, the extension side sub valve 12, the compression side sub valve 13, and the suction check valve 14 can be easily installed, improving assemblability.

Note that, although it has been described that the compression side chamber R2 and the intermediate chamber R3 are separated by the first partition wall 15, and the reservoir R and the intermediate chamber R3 are separated by the second partition wall 20, the reservoir R and the intermediate chamber R3 may be separated by the first partition wall 15, and the compression side chamber R2 and the intermediate chamber R3 may be separated by the second partition wall 20. Therefore, the compression side main valve 11 and the compression side sub valve 13 may be provided in series, with the compression side main valve 11 being disposed on the upstream side and the compression side sub valve 13 being disposed on the downstream side, between the compression side chamber R2 and the reservoir R, the extension side sub valve 12 and the suction check valve 14 may be provided in series, with the extension side sub valve 12 being disposed on the upstream side and the suction check valve 14 being disposed on the downstream side, between the reservoir R and the compression side chamber R2. The extension side sub valve 12 and the compression side main valve 11 may be provided on one of the first partition wall 15 and the second partition wall 20, and the compression side sub valve 13 and the suction check valve 14 may be provided on the other of the first partition wall 15 and the second partition wall 20. However, in an existing double-cylinder shock absorber D, the compression side main valve 11 and the suction check valve 14 are provided in a valve case attached to an end of the cylinder 1. Therefore, if the valve case is used as the second partition wall 20, the shock absorber D of the present embodiment can be realized only by installing the first partition wall 15 including the extension side sub valve 12 and the compression side sub valve 13 in the existing double-cylinder shock absorber, which is advantageous in that costs and design changes can be minimized.

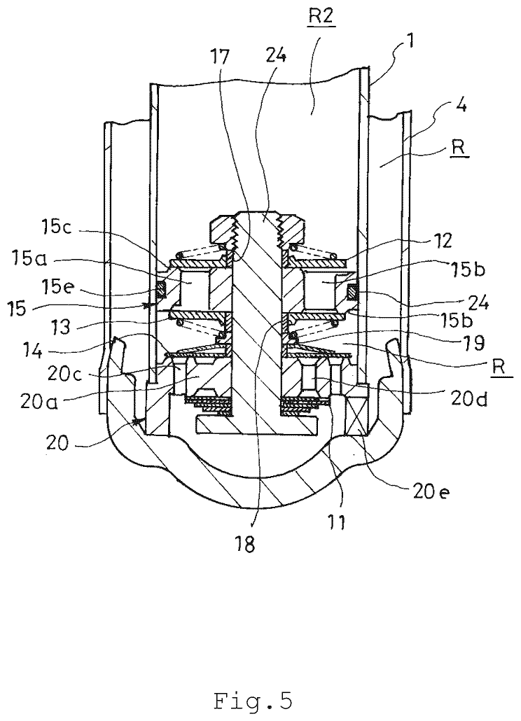

In addition, in the present embodiment, the first partition wall 15 is fixed to the cylinder 1 using the caulking portion la formed by caulking the cylinder 1 from the outer circumference. However, as illustrated in FIG. 5, the second attachment shaft and the first attachment shaft may be configured as a single attachment shaft 23, the second partition wall 20 and the first partition wall 15 may be connected by the attachment shaft 23, and a seal ring 24 that fits tightly against the inner circumference of the cylinder 1 may be placed in the annular shape groove 15e on the outer circumference of the first partition wall 15 to seal a space between the compression side chamber R2 and the intermediate chamber R3. By doing so, the first partition wall 15, the second partition wall, the compression side main valve 11, the extension side sub valve 12, the compression side sub valve 13, and the suction check valve 14 can be assembled in advance to form a valve assembly, and the valve assembly can be assembled to the shock absorber D, further improving the assemblability of the shock absorber D. In a case where the outer circumference of the first partition wall 15 is not in contact with the cylinder 1, a partition tube may be provided between a lower end of the first partition wall 15 and an upper end of the second partition wall 20, and the intermediate chamber R3 positioned in the partition tube between the first partition wall 15 and the second partition wall 20 may be separated in the cylinder 1. The partition tube may be provided separately from the first partition wall 15 and the second partition wall 20, may be provided integrally with the first partition wall 15, or may be provided integrally with the second partition wall 20.

Further, in the shock absorber D according to the present embodiment, the extension side sub valve 12 includes an extension side valve body 12a having an annular shape, entirely movable toward and away from the first partition wall 15, and closing the first extension side port 15a without any gap when abutting against a piston side end of the first partition wall 15, and an extension side spring 12b biasing the extension side valve body 12a in a direction to be seated on the first partition wall 15, and the compression side sub valve 13 includes a compression side valve body 13a having an annular shape, entirely movable toward and away from the first partition wall 15, and closing the first compression side port 15b without any gap when abutting against a counter piston side end of the first partition wall 15, and a compression side spring 13b biasing the compression side valve body 13a in a direction to be seated on the first partition wall 15.

According to the shock absorber D configured as described above, since the extension side sub valve 12 and the compression side sub valve 13 close the first extension side port 15a and the first compression side port 15b corresponding thereto without any gap, no orifice or choke exists, and the damping force can be increased from a very low speed range of the piston speed. Furthermore, since the extension side valve body 12a and compression side valve body 13a entirely move toward and away from the first partition wall 15, the passage area can be increased after valve is opened. As a result, when it is desired to generate a damping force through the extension side main valve 7 and the compression side main valve 11, the extension side sub valve 12 and the compression side sub valve 13 do not have an influence, and the extension side sub valve 12 does not cause a liquid suction failure in the cylinder 1 when the shock absorber D is extended.

Note that the extension side sub valve 12 and the compression side sub valve 13 may be leaf valves in which the extension side valve body 12a and the compression side valve body 13a are fixed to the first attachment shaft 16 on their inner circumferential sides and allowed to deflect on their outer circumferences, but may also be a de-carbon valve including an inner valve seat and an outer valve seat having different diameters, and an annular shape leaf valve that can be opened both inward and outward with its inner circumferential side of one end face being seated on the inner valve seat and its outer circumferential side of one end face being seated on the outer valve seat, although not illustrated, as disclosed in JP 2004-225834 A. In addition, as disclosed in JP 2019-116902 A, the extension side sub valve 12 and the compression side sub valve 13 may be an annular shape valve in which one of an inner circumferential side and an outer circumferential side of each of the extension side valve body 12a and the compression side valve body 13a is fixed, and the other is bent toward reservoir R to allow a flow of liquid from the compression side chamber R2 toward the reservoir R, or the other is bent toward the compression side chamber R2 to allow a flow of liquid from the reservoir R toward the compression side chamber R2. In this manner, the extension side sub valve 12 and the compression side sub valve 13 may be realized by a single valve capable of giving resistance to a flow of liquid from the compression side chamber R2 toward the reservoir R and giving resistance to a flow of liquid from the reservoir R toward the compression side chamber R2.

Further, in the shock absorber D according to the present embodiment, the extension side main valve 7 is an annular shape leaf valve, with an inner diameter of the extension side valve body 12a being smaller than an inner diameter of the extension side main valve 7, or the compression side main valve 11 is an annular shape leaf valve, with an inner diameter of the compression side valve body 13a being smaller than an inner diameter of the compression side main valve 11.

According to the shock absorber D configured as described above, the difference between the inner and outer diameters of the extension side valve body 12a or the compression side valve body 13a having an annular shape can be large, and a large passage area can be ensured after the valve is opened. This eliminates the risk that the extension side sub valve 12 generates a larger damping force than the extension side main valve 7, or that the compression side sub valve 13 generates a larger damping force than the compression side main valve 11. Note that the extension side main valve 7 may be an annular shape leaf valve, with an inner diameter of the extension side valve body 12a being smaller than an inner diameter of the extension side main valve 7, and the compression side main valve 11 may be an annular shape leaf valve, with an inner diameter of the compression side valve body 13a being smaller than an inner diameter of the compression side main valve 11.

Note that, although the collars 17 and 18 are used as center rods in the present embodiment, the first attachment shaft 16 may be used as a center rod without the collars 17 and 18, or a center rod may be integrally provided on the first partition wall 15.

Although the preferred embodiment of the present invention has been described in detail above, modifications, variations, and changes can be made without departing from the claims.

### REFERENCE SIGNS LIST

1 Cylinder
2 Piston rod
2a Piston fitting portion
3 Piston
4 Outer tube
7 Extension side main valve
11 Compression side main valve
12 Extension side sub valve
12a Extension side valve body
12b Extension side spring
13 Compression side sub valve
13a Compression side valve body
13b Compression side spring
14 Suction check valve
15 First partition wall
15a First extension side port
15b First compression side port
20 Second partition wall
20a Second extension side port
20b Second compression side port
D Shock absorber
R Reservoir
R1 Extension side chamber
R2 Compression side chamber
R3 Intermediate chamber
W Partition wall member

1. A shock absorber comprising:
a cylinder;
a piston rod inserted into the cylinder so as to be movable in an axial direction;
a piston connected to the piston rod, and inserted into the cylinder so as to movable in the axial direction to partition the inside of the cylinder into an extension side chamber and a compression side chamber filled with liquid;
an outer tube covering an outer circumference of the cylinder to form a reservoir between the outer tube and the cylinder;
an extension side main valve giving resistance to a flow of liquid from the extension side chamber toward the compression side chamber;
a compression side main valve and a compression side sub valve provided in series between the compression side chamber and the reservoir, and giving resistance to a flow of liquid from the compression side chamber toward the reservoir;
an extension side sub valve provided between the reservoir and the compression side chamber, and giving resistance to a flow of liquid from the reservoir toward the compression side chamber; and
a suction check valve provided in series with the extension side sub valve between the reservoir and the compression side chamber, and allowing only a flow of liquid from the reservoir toward the compression side chamber,
wherein a damping force is generated only by the extension side sub valve when a piston speed is in a very low speed range during an extension operation, and
a damping force is generated only by the compression side sub valve when a piston speed is in the very low speed range during a contraction operation.

2. The shock absorber according to claim 1, further comprising:
a partition wall member having a first partition wall and a second partition wall forming an intermediate chamber between the first partition wall and the second partition wall, and partitioning the compression side chamber and the reservoir,
wherein the first partition wall has a first extension side port and a first compression side port allowing communication between one of the compression side chamber and the reservoir and the intermediate chamber,
the second partition wall has a second extension side port and a second compression side port allowing communication between the other of the compression side chamber and the reservoir and the intermediate chamber,
the extension side sub valve and the compression side sub valve are provided on the first partition wall, and
the compression side main valve and the suction check valve are provided on the second partition wall.

3. The shock absorber according to claim 2, wherein
the extension side sub valve includes:
an extension side valve body having an annular shape, entirely movable toward and away from the first partition wall, and closing the first extension side port without any gap when abutting against a piston side end of the first partition wall; and
an extension side spring biasing the extension side valve body in a direction to be seated on the first partition wall, and
the compression side sub valve includes:
a compression side valve body having an annular shape, entirely movable toward and away from the first partition wall, and closing the first compression side port without any gap when abutting against a counter piston side end of the first partition wall; and
a compression side spring biasing the compression side sub valve body in a direction to be seated on the first partition wall.

4. The shock absorber according to claim 3, wherein
the extension side main valve is an annular shape leaf valve, with an inner diameter of the extension side valve body being smaller than an inner diameter of the extension side main valve, or the compression side main valve is an annular shape leaf valve, with an inner diameter of the compression side valve body being smaller than an inner diameter of the compression side main valve.
